(19) United States
(12) Patent Application Publication
(10) Pub. No.: US 2026/0055753 A1
(43) Pub. Date: Feb. 26, 2026

(54) UNDERWATER WING-KITE SYSTEM FOR ENERGY GENERATION AND WATER CIRCULATION

(71) Applicant: Gerald L. Barber, Greenville, SC (US)

(72) Inventor: Gerald L. Barber, Greenville, SC (US)

(21) Appl. No.: 19/264,418

(22) Filed: Jul. 9, 2025

Related U.S. Application Data
(63) Continuation of application No. 19/094,925, filed on Mar. 30, 2025, now Pat. No. 12,454,931.
Application No. 19/094,925 is a continuation-in-part of application No. 18/469,447, filed on Sep. 18, 2023, now abandoned.
(60) Provisional application No. 63/407,638, filed on Sep. 17, 2022.
(60) Provisional application No. 63/418,369, filed on Oct. 21, 2022.

(51) Int. Cl. F03B 13/10; F03B 3/12; F03B 17/06

(52) U.S. Cl. CPC F03B 13/10; F03B 3/126; F03B 17/06; F05B 2220/706; F05B 2260/42; F05B 2260/70; F05B 2270/20

(57) ABSTRACT

A marine energy system comprising: a torpedo housing; a wing housing coupled to and separated from the torpedo housing by a shaft; and an energy converter located within the torpedo housing, wherein the wing housing is configured to move through a fluid current to drive the energy converter. The energy converter may comprise a generator configured to produce electrical energy or a pump adapted to move fluid from a depth location to a shallow location. The wing housing may be configured to move in a figure-8 pattern through the fluid current at 4-8 times the speed of the fluid current. A propeller may be coupled to the wing housing and configured to drive the energy converter.

### CROSS-REFERENCE TO RELATED APPLICATIONS

This application is a continuation in part from U.S. patent application Ser. No. 19/171,228 filed Apr. 5, 2025 which is a continuation in part from U.S. patent application Ser. No. 19/094,925 filed Mar. 30, 2025 which is a continuation in part of U.S. patent application Ser. No. 18/469,447 filed Aug. 18, 2003 which claims benefit of U.S. Provisional Patent Applications 63/418,339 and 63/418,369 both filed Oct. 21, 2022 and 63/407,638 filed Sep. 17, 2022, all of which is incorporated by reference.

### BACKGROUND

### 1) Field of the Invention

The present disclosure relates to underwater energy generation and water circulation systems, and more particularly to an underwater kite and wing system that harnesses ocean currents to generate power and pump nutrient-rich deep water to shallower depths.

### 2) Description of Related Art

Ocean currents represent a vast, largely untapped source of renewable energy and potential for enhancing marine ecosystems. Harnessing these currents for power generation and nutrient circulation has long been a goal in the fields of renewable energy and ocean engineering. However, effectively capturing energy from ocean currents while simultaneously facilitating the transfer of nutrient-rich deep water to shallower depths presents significant technical challenges.

One of the primary difficulties in designing systems for underwater energy generation and water circulation is achieving efficient movement through water currents. Traditional fixed or tethered underwater turbines are limited in their ability to adapt to changing current directions and velocities. This limitation reduces their overall energy capture potential and restricts their deployment to specific locations with consistent current patterns.

A more dynamic approach involves the use of underwater kite or wing-like structures that can move through the water in controlled patterns. The ability to utilize currents and travel in a figure-8 trajectory is particularly advantageous for several reasons. This movement pattern allows the system to sweep through a larger cross-section of the current, potentially increasing energy capture. Additionally, the figure-8 pattern can help maintain a consistent average position in the water column, which is beneficial for both power generation and water pumping operations.

However, implementing such a movement pattern in underwater conditions presents numerous engineering challenges. The forces exerted by ocean currents can be substantial and unpredictable, making precise control of the system's trajectory difficult. Furthermore, the components required for power generation, such as generators, gearboxes, and pumps, add considerable weight to the underwater kite or wing structure. This increased mass affects the system's maneuverability and responsiveness to current changes.

The weight of these components also impacts the system's inertia, making it more challenging to initiate and maintain the desired figure-8 pattern. Overcoming these inertial forces requires careful design considerations and may necessitate additional energy expenditure, potentially reducing the overall efficiency of the system. Moreover, the added weight can affect the buoyancy and stability of the structure, further complicating its ability to maintain an optimal position in the water column for energy capture and water pumping.

Existing underwater energy generation systems often struggle to balance the need for robust power generation equipment with the requirement for a hydrodynamic, maneuverable structure. This trade-off frequently results in designs that are either too heavy and immobile to effectively utilize ocean currents or too lightweight to house sufficient power generation and pumping capacity.

Given these challenges, there is a clear need for innovative approaches to underwater energy generation and water circulation systems. Such approaches must address the complexities of controlled movement in ocean currents while also accommodating the necessary components for effective power generation and water transfer. Advancements in this area have the potential to significantly impact renewable energy production and contribute to the health and productivity of marine ecosystems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present invention addresses the critical need for upwelling in marine environments, which is essential for nutrient circulation and ecosystem health. Natural upwelling zones account for only about 20% of the ocean but produce over 50% of the world's seafood harvest. By artificially inducing upwelling, the invention aims to increase ocean productivity, enhance marine biodiversity, and potentially mitigate climate change through increased carbon dioxide absorption by phytoplankton.

This invention provides a novel approach to offshore power generation that does not rely on conventional windmills or fuel-based systems. By harnessing the kinetic energy of ocean currents, particularly strong currents like the Gulf Stream, the device can produce sustainable energy in offshore locations without the visual impact or space requirements of traditional wind farms. The system's unique design, featuring a wing housing that moves in a figure-8 pattern through the fluid current at 4-8 times the speed of the current itself, allows for efficient energy capture and conversion.

However, the placement of critical components such as generators or pumps within the wings of the device presents several challenges. These include issues related to weight distribution, maintenance accessibility, and potential exposure to harsh marine conditions. The invention addresses these concerns by separating the energy conversion components from the wing housing. A torpedo housing, coupled to and separated from the wing housing by a shaft, contains the energy converter (either a generator or a pump). This configuration allows the wing to move more freely through the water, reducing drag and increasing efficiency, while protecting the sensitive equipment within the more hydrodynamic and stable torpedo housing.

The foregoing general description of the illustrative embodiments and the following detailed description thereof are merely exemplary aspects of the teachings of this disclosure and are not restrictive.

### BRIEF DESCRIPTION OF FIGURES

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 illustrates a side view of an underwater power generation system, according to aspects of the present disclosure.

FIG. 2 illustrates an orthogonal side view of an underwater power generation system, according to an embodiment.

FIG. 3 illustrates a view of a torpedo assembly for an underwater power generation system, according to aspects of the present disclosure.

FIG. 4A illustrates a view of a torpedo assembly for an underwater power generation system, according to aspects of the present disclosure.

FIG. 4B illustrates a view of a torpedo assembly for an underwater power generation system, according to aspects of the present disclosure.

FIG. 5 illustrates an orthogonal side views of an underwater power generation and fluid transfer system, according to an embodiment.

FIG. 6 illustrates an orthogonal side views of an underwater power generation and fluid transfer system, according to an embodiment.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure. Modifiers such as “first” and “second” may be used to differentiate elements, but the modifiers do not necessarily indicate any particular order.

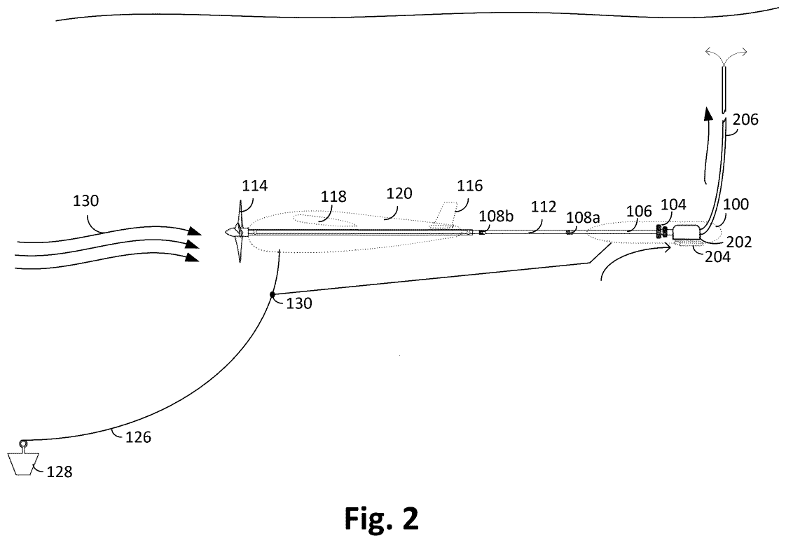

Referring to FIG. 2, a system for artificial upwelling may include a torpedo housing 100 connected to a wing housing 120. The torpedo housing 100 and wing housing 120 may be coupled via a torpedo shaft 106. In some cases, the torpedo shaft 106 may include torpedo shaft joints 108a and 108b that allow for articulation between the torpedo housing 100 and wing housing 120.

The system may include a pump 202 disposed within the torpedo housing 100. A fluid intake 204 may be positioned on the torpedo housing 100 to receive water from deeper ocean depths. The pump 202 may draw water through the fluid intake 204 and discharge it through a fluid output 206. This configuration may allow the system to transfer water from deeper ocean depths toward shallower depths, creating artificial upwelling.

In some implementations, the system may include a propeller 114 mounted to the wing housing 120. The propeller 114 may have a diameter of approximately 20 feet. The propeller 114 may be configured to be driven by ocean currents, which may provide power for the pump 202 to facilitate water transfer.

An anchor line 126 may extend from an anchor connection 130 on the system to an anchor 128 that secures the system in position within the ocean current. In some cases, the anchor line 126 may have a Y-shaped configuration connecting to the wing housing 120 at two laterally spaced points. This arrangement may help maintain the system's orientation and depth during operation while allowing for some movement in response to changing current conditions.

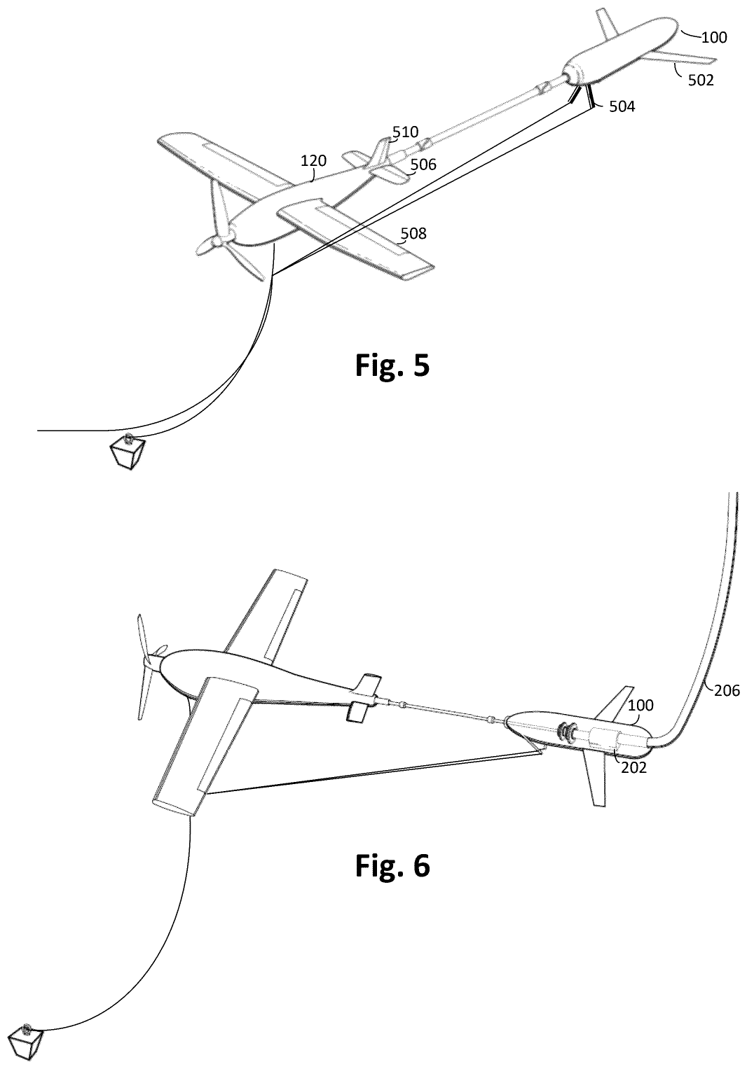

Referring now to FIGS. 5 and 6, additional components of the artificial upwelling system may be illustrated. The system may include a torpedo wing 502 extending from the torpedo housing 100. A torpedo lateral stabilizer 504 may provide additional stability during operation. In some implementations, a rear wing 506 may be positioned behind the torpedo wing 502.

The system may also include control surfaces to maintain proper positioning within ocean currents. A lateral control surface 508 and a vertical control surface 510 may be attached to provide directional control and orientation stability. The arrangement of these control surfaces may allow the system to maintain proper positioning while facilitating efficient fluid transfer operations.

The positioning of the torpedo wing 502, rear wing 506, and associated control surfaces (508, 510) may allow the system to respond to changing current conditions while maintaining consistent fluid transfer through the pump 202 and fluid output 206. The torpedo lateral stabilizer 504 may work in conjunction with the other control surfaces to maintain the system's orientation during operation.

This configuration of components may create a hydrodynamic profile that facilitates efficient operation in underwater conditions while maintaining stability during fluid transfer operations. The artificial upwelling system may thus be capable of pumping nutrient-rich water from deeper ocean depths to shallower depths, potentially enhancing marine ecosystems and productivity in the upper layers of the ocean.

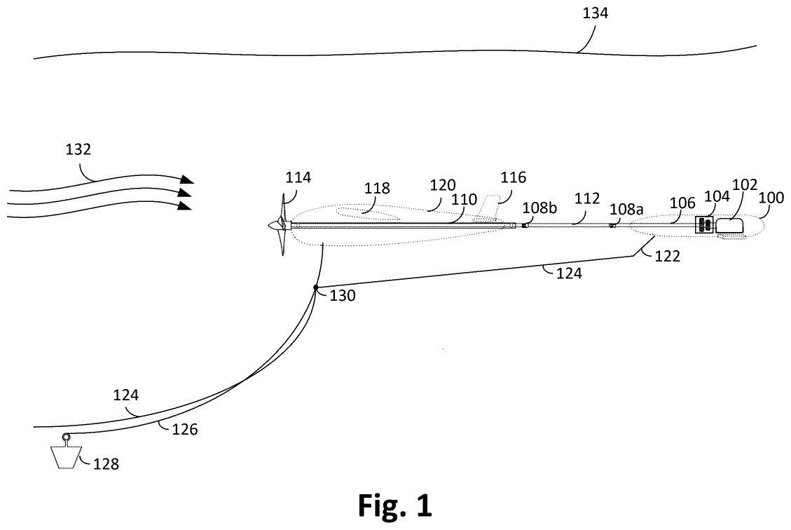

Referring to FIG. 1, a system for power generation in ocean currents may include a torpedo housing 100 connected to a wing housing 120 via a torpedo shaft 106. The torpedo shaft 106 may include torpedo shaft joints 108a and 108b that allow for articulation between the torpedo housing 100 and wing housing 120. A wing shaft 110 may extend from the wing housing 120, and a connection shaft 112 may connect the wing shaft 110 to the torpedo shaft 106.

In some cases, a generator 102 and a gear box 104 may be housed within the torpedo housing 100. The generator 102 may be enclosed in a waterproof pipe to protect it from the underwater environment. A propeller 114 may be mounted at one end of the system to capture energy from water current 132. The propeller 114 may drive the generator 102 through the connected shafts and joints to produce electrical power.

The wing shaft 110 may have a wingspan of 10-14 feet and a chord length of 10-12 feet. In some implementations, the wing shaft 110 may be configured to move in a figure-8 pattern through the water. This movement pattern may allow the wing shaft 110 to travel at 4-8 times the speed of the ocean current 132, potentially increasing the system's power generation capabilities.

A wing stabilizer 116 and front wing 118 may provide stability and control surfaces for the system. In some cases, the wing shaft 110 may include trim tabs to help maintain horizontal orientation during operation.

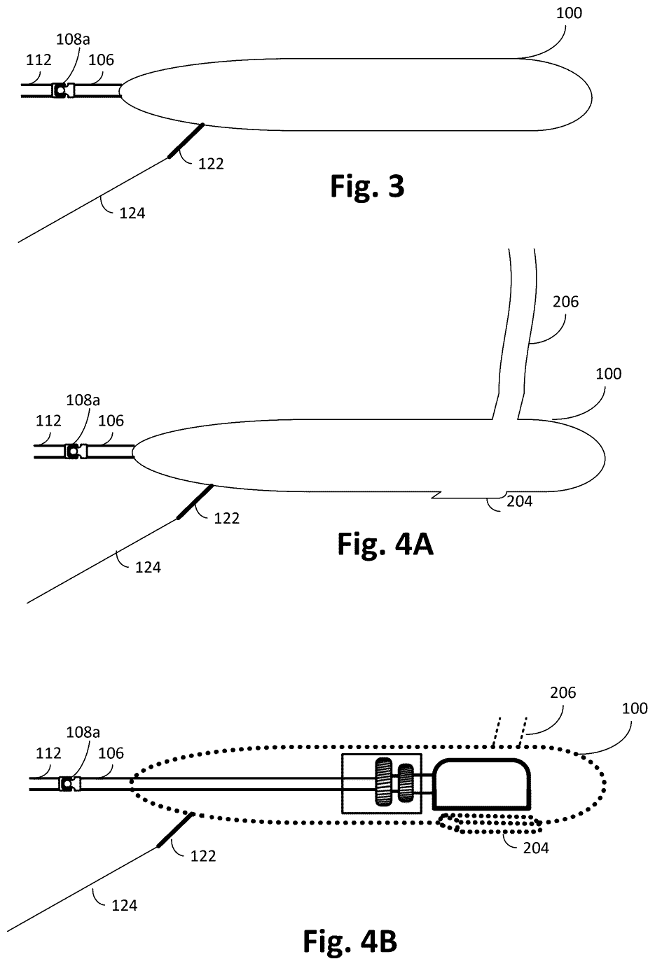

Referring now to FIGS. 3 and 4A-4B, additional details of the power generation system may be illustrated. A torpedo central stabilizer 122 may extend from the torpedo housing 100 to help maintain orientation in the water current 132. A power line 124 may run along the system to transmit electrical power generated by the generator 102.

In some implementations, the system may be capable of generating 10 megawatts of continuous electricity because energy generated is the cube of the fluid speed. The power generated may be transmitted through the power line 124 for use or storage.

An anchor line 126 may extend down to an anchor 128 that secures the system to the ocean floor through an anchor connection 130. The anchor line 126 may help maintain the system's position relative to the water current 132 while allowing some movement.

The system may be positioned below the water surface 134. The arrangement of components may allow the system to maintain a stable position in the water current 132 while the propeller 114 drives the generator 102 to produce electrical power.

In some cases, the system may include energy storage devices. These energy storage devices may include battery packs or capacitors. The energy storage devices may be used to store excess power generated by the system or to provide power during periods of lower current flow.

According to an aspect of the present disclosure, a marine energy system is provided. The system includes a torpedo housing, a wing housing coupled to and separated from the torpedo housing by a shaft, and an energy converter located within the torpedo housing. The wing housing is configured to move through a fluid current to drive the energy converter.

According to other aspects of the present disclosure, the marine energy system may include one or more of the following features. The energy converter may comprise a generator configured to produce electrical energy. The system may further comprise a propeller coupled to the wing housing and configured to drive the energy converter. The energy converter may comprise a pump adapted to move fluid from a depth location to a shallow location. The wing housing may be configured to move in a figure-8 pattern through the fluid current. The wing housing may be configured to move at 4-8 times the speed of a fluid current.

According to another aspect of the present disclosure, a marine energy system is provided. The system includes a torpedo body, a wing attached to the torpedo body, a propeller coupled to the wing, and an energy converter disposed within the torpedo body and operatively connected to the propeller. Movement of the wing through a fluid current drives the propeller to generate power via the energy converter.

According to other aspects of the present disclosure, the marine energy system may include one or more of the following features. The energy converter may be driven by a shaft adapted to transfer rotational energy from the propeller to the energy converter. The propeller may be an impeller. The energy converter may be taken from the group of a pump and an electrical generator. The propeller may be coupled to the wing by a shaft. The shaft may include a first portion and a second portion. The first portion and the second portion may be connected by a joint adapted to allow the torpedo housing to drift out of line with the wing. The system may further comprise an anchor line connected to the wing for securing the system in position within the fluid current.

According to another aspect of the present disclosure, a marine energy system is provided. The system includes a submersible torpedo, a wing coupled to the torpedo, a pump disposed within the torpedo, and a fluid intake and a fluid output in fluid communication with the pump. Movement of the wing through a fluid current powers the pump to transfer fluid from the fluid intake to the fluid output.

According to other aspects of the present disclosure, the marine energy system may include one or more of the following features. The wing may be configured to move in a figure-8 pattern through the fluid current. The torpedo housing may be at a depth in excess of 1000 feet and the pump may be adapted to transfer fluid from this depth to near a surface. The fluid intake may be positioned to receive water from a first depth and the fluid output may be positioned to discharge water at a second depth shallower than the first depth. The system may further comprise a propeller coupled to the wing and operatively connected to the pump. The propeller may have a diameter of approximately 20 feet.

One or more different inventions may be described in the present application. Further, for one or more of the invention(s) described herein, numerous embodiments may be described in this patent application, and are presented for illustrative purposes only. The embodiments described are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A marine energy system comprising:
a torpedo housing;
a wing housing coupled to and separated from the torpedo housing by a shaft; and
an energy converter located within the torpedo housing, wherein the wing housing is configured to move through a fluid current to drive the energy converter.

2. The marine energy system of claim 1, wherein the energy converter comprises a generator configured to produce electrical energy.

3. The marine energy system of claim 1, further comprising a propeller coupled to the wing housing and configured to drive the energy converter.

4. The marine energy system of claim 1, wherein the energy converter comprises a pump adapted to move fluid from a depth location to a shallow location.

5. The marine energy system of claim 1, wherein the wing housing is configured to move in a figure-8 pattern through the fluid current.

6. The marine energy system of claim 1, wherein the wing housing is configured to move at 4-8 times the speed of a fluid current.

7. A marine energy system comprising:
a torpedo body;
a wing attached to the torpedo body;
a propeller coupled to the wing; and
a energy converter disposed within the torpedo body and operatively connected to the propeller, wherein movement of the wing through a fluid current drives the propeller to generate power via the energy converter.

8. The marine energy system of claim 7, wherein the energy converter is driven to the by a shaft adapted to transfer rotational energy from the propeller to the energy converter.

9. The marine energy system of claim 7, wherein the propeller is an impeller.

10. The marine energy system of claim 7, wherein the energy converter is taken from the group of a pump and an electrical generator.

11. The marine energy system of claim 7 wherein the propeller is coupled to the wing by a shaft.

12. The marine energy system of claim 11 wherein the shaft include a first portion and a second portion.

13. The marine energy system of claim 12 wherein the first portion and the second portion are connected by a joint adapted to allow the torpedo housing to drift out of line with the wing.

14. The marine energy system of claim 7, further comprising an anchor line connected to the wing for securing the system in position within the fluid current.

15. A marine energy system comprising:
a submersible torpedo;
a wing coupled to the torpedo;
a pump disposed within the torpedo; and
a fluid intake and a fluid output in fluid communication with the pump, wherein movement of the wing through a fluid current powers the pump to transfer fluid from the fluid intake to the fluid output.

16. The marine energy system of claim 15, wherein the wing is configured to move in a figure-8 pattern through the fluid current.

17. The marine energy system of claim 15 wherein the torpedo housing is at a depth in excess of 1000 feet and the pump is adapted to transfer fluid from this depth to near a surface.

18. The marine energy system of claim 15, wherein the fluid intake is positioned to receive water from a first depth and the fluid output is positioned to discharge water at a second depth shallower than the first depth.

19. The marine energy system of claim 18, further comprising a propeller coupled to the wing and operatively connected to the pump.

20. The marine energy system of claim 19, wherein the propeller has a diameter of approximately 20 feet.
